(19) United States
(12) Patent Application Publication
(10) Pub. No.: US 2011/0160037 A1
(43) Pub. Date: Jun. 30, 2011

(54) Carbon Nanofiber-Metal Composite and Method for Preparing the Same

(75) Inventors: Kyoung Tae Youm, Uiwang-si (KR); Young Sil Lee, Uiwang-si (KR)

(73) Assignee: CHEIL INDUSTRIES INC., Gumi-si (KR)

(21) Appl. No.: 12/968,407

(22) Filed: Dec. 15, 2010

(30) Foreign Application Priority Data
Dec. 30, 2009 (KR) 10-2009-0133885

(51) Int. Cl. H01B 1/04; B01J 35/02; B82Y 30/00

(52) U.S. Cl. 502/1; 252/503; 977/734

(57) ABSTRACT

The present invention provides a carbon nanofiber-metal composite, which is formed by continuously coating a carbon nanofiber including a plurality of laminated truncated, conic graphenes with a metal. The carbon nanofiber-metal composite according to the present invention can have improved magnetic permeability and conductivity, and thus can be useful as an electromagnetic shielding material.

### CROSS-REFERENCE TO RELATED APPLICATIONS

This application claims priority from Korea Patent Application No. 2009-0133885, filed Dec. 30, 2009, in the Korean Intellectual Property Office, the disclosure of which is incorporated herein by reference in its entirety.

### FIELD OF THE INVENTION

The present invention relates to a carbon nanofiber-metal composite and method for preparing the same.

### BACKGROUND OF THE INVENTION

Electromagnetic pollution is steadily increasing in daily life because the electromagnetic spectrum being used is moving to a higher frequency band, due to the increasing multifunctionality and miniaturization of electrical and electronic products and the development of information and communication equipment. Because of this phenomenon, the electromagnetic spectrum radiated from certain sources may cause malfunctions and system errors in surrounding devices and may also damage the human body, such as inducing fever. Therefore, there is increasing demand for electromagnetic shielding technology, which can effectively prevent these problems.

Conventionally, electromagnetic shielding technologies use metal instruments or metal painted or plated conductive membranes. However, if a metal instrument has a complex pattern, processability can deteriorate and the weight of the metal instrument can increase. Further, plating technologies can require complex processes, such as grease removal, etching, neutralizing, activating, accelerating, metalizing, activating, first plating, second plating, and third plating steps, which can impact productivity.

In contrast, electrical conducting and electromagnetic shielding materials using polymer composite resins may have an advantage in terms of production cost and processability, because composite resin products can be produced by injection molding processes.

Electromagnetic Interference (EMI) shielding effectiveness may be represented by the following expression:

Shielding Effectiveness (S.E.)=R+A+B

wherein R is surface reflection of electromagnetic radiation, A is internal absorption of electromagnetic radiation, and B is loss caused by multi-reflection.

In the case of metal materials, electromagnetic shielding effectiveness due to surface reflection of electromagnetic radiation can be high because of the higher conductivity (lower impedance) of metal materials. In order to increase the electromagnetic shielding effectiveness of a resin composite, a filler having high magnetic permeability can be used. Fillers with high magnetic permeability can increase electrical conductivity and surface reflection and also increase absorption of electromagnetic radiation. Therefore, the demand for filler satisfying these conditions and having high magnetic permeability and electric conductivity is increasing. Further, there is a need for a fiber shape which can easily form a network structure even in small amounts. Also, there is a need for the development of filler having a hollow structure.

Korean Application Publication No. 10-2007-0041024 discloses an electroless plating process for coating carbon nanotubes. However, the metal layer is partially coated and the coating thickness of the metal layer is very thin. Thus, the metal coated carbon nanotubes would not be expected to exhibit sufficient surface reflection caused by conductivity and/or absorption effect caused by magnetic permeability of the metal.

Japanese Patent Publication No. 1999-193473 discloses electroless plating of carbon fibers and removing the carbon fiber after oxidation to form a hollow metal fiber. Also, Korean Application Publication No. 10-2009-0085801 discloses electroless plating of a synthetic fiber and removing the synthetic fiber to form a hollow metal fiber. However, these methods have a disadvantage in terms of production cost, because the processes require high temperature heat treatment to remove the fibers to reduce weight. In addition, the high temperature heat treatment process can melt the plated metal and destroy the manufactured fiber structure.

Electroless plating of vapor grown carbon fiber (VGCF: product name of Showa Denko Co.) is another method for coating carbon fiber with metal layer. See Jaejeung Han, Fabrication and Microstructure of Metal-Coated Carbon Nanofibers using Electroless Plating, The Journal of the Korean Society for Composite Materials, Vol. 20, No. 5, pp. 43-48 (2007). However, it is expected that a high temperature reaction should be carried out when electroless plating, and that when preparing composite materials the weight thereof would be increased, because of the thick coating layer.

U.S. Pat. No. 5,827,997 discloses a method for coating a metal layer by electroplating. However, it is expected that the effect of electromagnetic absorption would be reduced, because the metal layer only consists of pure nickel.

### SUMMARY OF THE INVENTION

The present invention provides a carbon nanofiber-metal composite that can have improved magnetic permeability and conductivity and thus can be useful as an electromagnetic shielding material.

The present invention further provides a method for making a carbon nanofiber-metal composite that can have improved magnetic permeability and conductivity which can be useful as an electromagnetic shielding material.

The carbon nanofiber-metal composite can be formed by continuously coating a carbon nanofiber including a plurality of laminated truncated, conic graphenes with a metal.

The carbon nanofiber can be in the form of a hollow tube (or a cup-stacked carbon nanofiber), the interior of which is empty.

Examples of the metal comprise Ni, Ni—P alloy, Ni—Fe alloy, Cu, Ag, Co, Sn, Pd, Au, and the like, and alloys thereof.

The carbon nanofiber-metal composite can have a linear structure.

The aspect ratio (Length/Diameter) of the carbon nanofiber-metal composite can be about 10 to about 200.

The weight ratio of carbon to metal in the carbon nanofiber-metal composite can be about 1:1 to about 1:6.

The metal coating layer can be formed on the outer wall, inside wall, or both of the inner and outer walls of the carbon nanofiber.

The method for preparing the carbon nanofiber-metal composite coated with metal comprises treating a carbon nanofiber including a plurality of laminated truncated, conic graphenes with an acid solution to activate a surface of the carbon nanofiber; washing the surface-activated carbon nanofiber and digesting the surface-activated carbon nanofiber with an acid solution in which a catalyst is dispersed to distribute the catalyst onto the surface of the carbon nanofiber; rewashing the carbon nanofiber on which the catalyst is distributed; and electroless plating the carbon nanofiber with a metal solution to form a metal coating layer.

The method for preparing the carbon nanofiber-metal composite coated with metal according to the present invention may further comprise a step of heat treating the carbon nanofiber on which the metal coating layer is formed.

The catalyst can be distributed so that the carbon nanofiber includes about 5 to about 50 catalyst particles per about 100 nm² of the surface area of the carbon nanofiber.

Examples of the metal source of the metal solution include Ni, Ni—P alloy, Ni—Fe alloy, Cu, Ag, Co, Sn, Pd, Au, and the like, and alloys thereof. The metal concentration in the metal solution can be about 0.01 to about 1 M.

### BRIEF DESCRIPTION OF DRAWINGS

FIG. 1 schematically illustrates a structure of a carbon nanofiber including a plurality of laminated truncated, conic graphenes having the form of a hollow tube, the interior of which is empty.

FIG. 2 is a scanning electron microscope image of a carbon nanofiber which can be used in the manufacture of the carbon nanofiber-metal composite according to one embodiment of the present invention.

FIG. 3 is a scanning electron microscope image of a carbon structure prepared according to another embodiment of the present invention in which Pd—Sn alloy nanoparticles are distributed on carbon nanofibers including a plurality of laminated truncated, conic graphenes.

FIG. 4 is a scanning electron microscope image of multi-wall carbon nanotubes according to a comparative example on which Pd—Sn alloy nanoparticles are distributed.

FIG. 5 is a scanning electron microscope image of a carbon nanofiber-metal composite according to another embodiment of the present invention.

FIG. 6 is a scanning electron microscope image of metal coated multi-wall carbon nanotubes of the comparative example.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention provides a carbon nanofiber-metal composite, which can be formed by continuously coating a carbon nanofiber including a plurality of laminated truncated, conic graphenes with a metal.

The carbon nanofiber-metal composite according to the present invention can have a large aspect ratio, which can improve the magnetic permeability and the conductivity of the carbon nanofiber-metal composite. Also, the thickness of the metal coating layer formed on the surface of the carbon-nanofiber can be adjusted, and the metal coating layer can be continuously formed. Thus the electrical conductivity of the carbon nanofiber-metal composite can be improved.

In one embodiment of the present invention, the carbon nanofiber is in the form of a hollow tube (or a cup-stacked carbon nanofiber) including a plurality of laminated truncated, conic graphenes and having an empty interior. This carbon nanofiber can exhibit increased conductivity compared to a carbon nanotube, because a uniform metal layer can be formed on the surface of the fiber.

The carbon nanofiber having the form of a hollow tube formed of a plurality of laminated truncated, conic graphenes and having an empty interior is a cup-stacked carbon nanofiber, i.e. a carbon nanofiber in which carbon network layers in the form of a bottomless cup are stacked, the middle is empty, as in the carbon nanotube, and the average diameter of which is about 50 to about 200 nm. The distance between each layer is the distance between the graphite layer and can generally be about 0.35 nm.

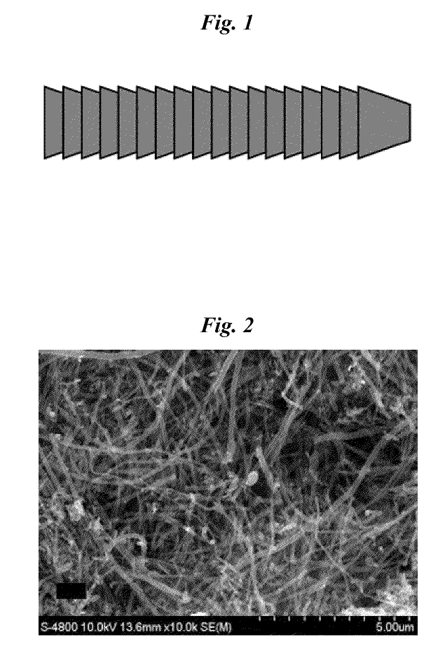

FIG. 1 schematically illustrates a structure of the carbon nanofiber which includes a plurality of laminated truncated, conic graphenes and which is in the form of hollow tube, the interior of which is empty. The laminated truncated, conic grapheme layers include exposed and reactive edges which can include reactive hydrogen atoms, which can function as chemically activatable positions, and the density of chemically activatable positions is much higher than that of conventional carbon nanotubes.

FIG. 2 is a scanning electron microscope image of a carbon nanofiber useful in the invention including a plurality of laminated truncated, conic graphenes and which is in the form of hollow tube, the interior of which is empty.

The weight ratio of carbon and metal in the carbon nanofiber-metal composite can be about 1:1 to about 1:6, and the thickness of the metal coating layer can be about 1 to about 1,000 nm. If the carbon nanofiber-metal composite includes a carbon:metal weight ratio and metal coating thickness within the above ranges, the electrical conductivity and the electromagnetic shielding ability of the same can be increased, and the weight of a molded article including the same may not be increased.

Examples of the metal in the metal coating layer can include without limitation Ni, Ni—P alloy, Ni—Fe alloy, Cu, Ag, Co, Sn, Pd, Au, and the like, alloys thereof, and combinations of two or more of the foregoing.

The carbon nanofiber-metal composite according to the present invention can further include a catalyst, because the carbon nanofiber-metal composite can be prepared by digesting the carbon nanofiber with a solution comprising the catalyst, and coating the resultant product with metal through using the catalyst as a medium for attaching the metal coating to the nanofiber. The catalyst may be Pd, Pd—Sn alloy, or a combination thereof.

When the carbon nanofiber has the form of a hollow tube including a plurality of laminated truncated, conic graphenes and an empty interior, the metal catalyst can be attached onto one or both sides of the carbon nanofiber wall, because of the hollow structure. For example, the metal catalyst can be attached onto a region connecting truncated, conic graphene layers on both sides of the carbon nanofiber wall. Further, when the metal is coated on the metal catalyst attached onto a region connecting the inside wall or the outer wall, the metal coating layer can be formed onto the inside wall and/or the outer wall of the carbon nanofiber using the catalyst particles as a medium for attaching the metal coating to the carbon nanofiber.

In another embodiment of the present invention, the carbon nanofiber-metal composite of the present invention can have a linear structure. The linear structure of the carbon nanofiber-metal composite of the present invention can be readily maintained. In contrast, the linear structure of a carbon nanotube is not well maintained, because the carbon nanotube can easily tangle with itself. Accordingly, the effective aspect ratio of the carbon nanofiber-metal composite can be larger than that of a carbon nanotube, and accordingly a very small amount of the carbon nanofiber-metal composite of the present invention can form a network which can impart good electric conductivity and electromagnetic shielding ability.

In exemplary embodiments of the present invention, the aspect ratio (Length/Diameter) of the carbon nanofiber-metal composite can be more than about 10, for example about 10 to about 200.

In other exemplary embodiments of the present invention, the average length of the carbon nanofiber-metal composite can be about 1 to about 10 μm, and the average diameter of the carbon nanofiber-metal composite can be about 10 to about 300 nm.

In other exemplary embodiments of the present invention, the specific resistance of the carbon nanofiber-metal composite can be about 0.01 to about 10⁰ Ω·cm.

The carbon nanofiber-metal composite can be prepared by an electroless plating method. In exemplary embodiments, the carbon nanofiber-metal composite according to the present invention may be prepared by the following method.

The method for preparing the carbon nanofiber-metal composite coated with metal can include treating a carbon nanofiber including a plurality of laminated truncated, conic graphenes with an acid solution to activate the surface of the carbon nanofiber; washing the surface-activated carbon nanofiber and digesting the surface-activated carbon nanofiber with an acid solution in which a catalyst is dispersed to distribute the catalyst onto the surface of the carbon nanofiber; rewashing the carbon nanofiber on which the catalyst is distributed; and electroless plating the carbon nanofiber with a metal solution to form a metal coating layer.

The method for preparing the carbon nanofiber-metal composite coated with metal in which the carbon nanofiber is coated with the metal by electroless plating can provide a metal nanofiber having a uniform (continuous) metal layer and a high aspect ratio. Also, the method for preparing the carbon nanofiber-metal composite allows the adjustment of the thickness of coating layer by changing the concentration of the metal solution and thus can provide a metal nanofiber having a desired diameter.

The method for preparing the carbon nanofiber-metal composite coated with metal according to the present invention may further comprise a step of heat treating the carbon nanofiber on which the metal coating layer is formed. Through the step of heat treating, the crystallinity of the metal coating layer can be improved, the contact resistance can be reduced, and accordingly the carbon-nanofiber-metal composite can be used as filler which can have effective electrical conductivity and electromagnetic shielding properties.

The heat treating may be performed at a temperature of about 390 to about 450° C. over a period of about 20 to about 40 minutes.

In one embodiment of the present invention, the carbon nanofiber can be in the form of a hollow tube (or a cup-stacked carbon nanofiber).

In exemplary embodiments of the present invention, the catalyst can be Pd, Pd—Sn alloy, or a combination thereof.

In other exemplary embodiments of the present invention, the catalyst can be distributed such that the number of catalyst particles is about 5 to about 50 catalyst particles per about 100 nm² of the surface area of the carbon nanofiber. If the catalyst is distributed in an amount within the above range, the metal coating layer can be formed continuously. If the catalyst is distributed in an amount less than the above range, the metal coating layer may be irregular. If the catalyst is distributed in an amount greater than the above range, excess metal catalyst can remain, which can increase manufacturing costs.

The acid solution for activating the surface of carbon nanofiber can include without limitation nitric acid, sulfuric acid, hydrochloric acid, or a combination thereof.

The acid solution in which the catalyst nanoparticles are dispersed can also include without limitation nitric acid, sulfuric acid, hydrochloric acid, or a combination thereof.

Examples of the metal source of the metal solution can include without limitation Ni, Ni—P alloy, Ni—Fe alloy, Cu, Ag, Co, Sn, Pd, Au, and the like, alloys thereof, and combinations of two or more thereof. The thickness of coating layer can be adjusted by changing the concentration of the metal solution. In exemplary embodiments, the concentration of the metal source in the metal solution can be about 0.01 to about 1 M, for example about 0.05 to about 0.1 M.

The invention may be better understood by reference to the following examples, and which are intended for the purpose of illustration and are not to be construed as in any way limiting the scope of the present invention, which is defined in the claims appended hereto.

### EXAMPLES

Carbon structures used in the Examples and Comparative Examples are as follows:

### (A) Example

A carbon nanofiber including a plurality of laminated truncated, conic graphenes, a diameter of 200 nm and a length of 5 μm is used.

FIG. 2 is a scanning electron microscope image of the carbon nanofiber used in the examples.

### (B) Comparative Example

A multi-wall carbon nanotube with a diameter of 100 nm is used.

In order to distribute the catalyst onto the carbon structures uniformly, the carbon structures are treated with concentrated nitric acid at 115° C. for 30 minutes, and then the carbon structures are washed with distilled water. Pd/Sn alloy nanoparticles are dispersed in an acid solution, the carbon structures are digested into the acid solution, and 1 M of diluted sulfuric acid is further added to the acid solution to accelerate the process. Then the carbon structures are rewashed with distilled water. The resultant carbon structures have Pd/Sn alloy nanoparticles distributed uniformly thereon.

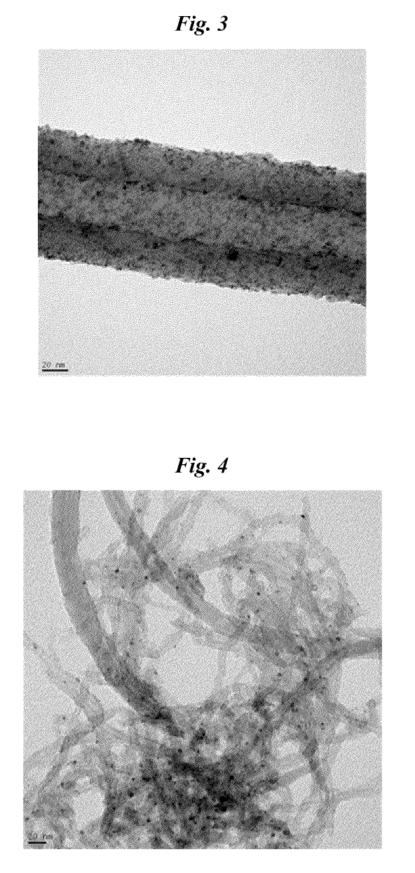

FIG. 3 is a scanning electron microscope image of the carbon structure of the example of the invention, in which the Pd—Sn alloy nanoparticles are distributed, and FIG. 4 is a scanning electron microscope image of the carbon structure of the comparative example, in which the Pd—Sn alloy nanoparticles are distributed.

Then, the carbon structures are dispersed by stirrer and subordinately ultrasonic oscillator, and the carbon structures are electroless plated with 0.1 M of NiSO₄6H₂O solution to obtain carbon structures coated with metal. Then the carbon structures coated with metal are heat treated at 450° C. for 20 minutes under an argon gas mixture.

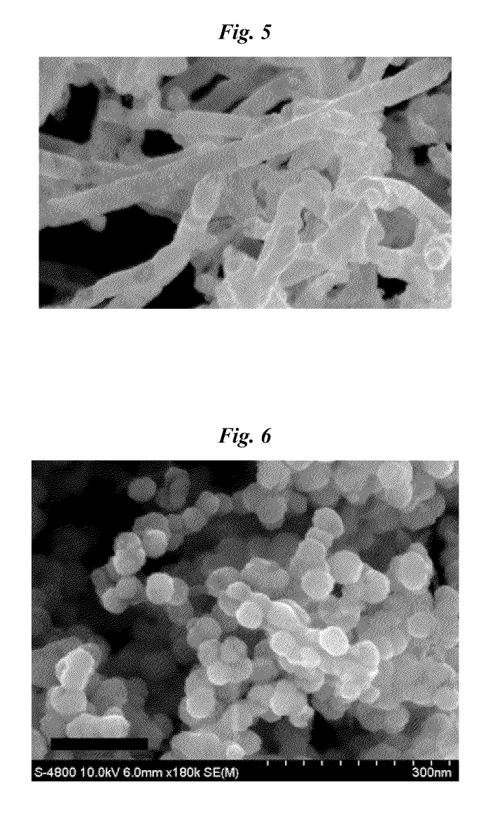

FIG. 5 is a scanning electron microscope image of the carbon nanofiber-metal composite of the example of the invention, and FIG. 6 is a scanning electron microscope image of the metal coated multi-wall carbon nanotubes of the comparative example.

TABLE 1

| | | Comparative |
|---|---|---|
| | Example | Example |
| Number of distributed | 15/100 nm² | 4/100 nm² |
| nanoparticles of Pd/Sn alloy | | |
| Coating uniformity | Good | Bad |

As shown above Table 1, the carbon structure of the example of the invention has a larger number of catalyst nanoparticles than the carbon structure of the comparative example. Also, as shown above Table 1 and FIGS. 5 and 6, the metal coating according to the example of the invention is continuous, whereas the metal coating according to the comparative example is discontinuous. Accordingly, it is expected that a resin comprising the metal coated multi-wall carbon nanotubes of the comparative example would have poor electric conductivity, because the metal coating is discontinuous and thus the electrical resistance of the resin would be high.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A carbon nanofiber-metal composite comprising a carbon nanofiber including a plurality of laminated truncated, conic graphenes and a continuous metal coating on the carbon nanofiber.

2. The carbon nanofiber-metal composite of claim 1, comprising a weight ratio of carbon to metal in the carbon nanofiber-metal composite of about 1:1 to about 1:6.

3. The carbon nanofiber-metal composite of claim 1, wherein said metal coating comprises Ni, Ni—P alloy, Ni—Fe alloy, Cu, Ag, Co, Sn, Pd, Au, an alloy thereof, or a combination of one or more of the foregoing.

4. The carbon nanofiber-metal composite of claim 1, wherein the aspect ratio (Length/Diameter) of the carbon nanofiber-metal composite is about 10 to about 200.

5. The carbon nanofiber-metal composite of claim 1, further comprising a metal catalyst.

6. The carbon nanofiber-metal composite of claim 5, comprising about 5 to about 50 catalyst particles per about 100 nm² of the surface area of the carbon nanofiber.

7. The carbon nanofiber-metal composite of claim 5, wherein the metal catalyst comprises Pd, Pd—Sn alloy, or a combination thereof.

8. The carbon nanofiber-metal composite of claim 1, wherein the carbon nanofiber further comprises a metal catalyst on a region of the nanofiber connecting one or more of the truncated, conic graphene layers on both sides of the carbon nanofiber wall.

9. The carbon nanofiber-metal composite of claim 1, wherein the carbon nanofiber-metal composite has an average length of about 1 to about 10 μm and an average diameter of about 5 to about 200 nm.

10. The carbon nanofiber-metal composite of claim 1, wherein the specific resistance of the carbon nanofiber-metal composite is about 0.01 to about 10⁰ Ω·cm.

11. The carbon nanofiber-metal composite of claim 1, wherein the metal is coated by an electroless plating method.

12. A method for preparing a carbon nanofiber-metal composite comprising:
activating a surface of a carbon nanofiber including a plurality of laminated truncated, conic graphenes;
washing the surface-activated carbon nanofiber and digesting the surface-activated carbon nanofiber with an acid solution in which a catalyst is dispersed to distribute the catalyst onto a surface of the carbon nanofiber;
rewashing the carbon nanofiber on which the catalyst is distributed; and
electroless plating the carbon nanofiber with a metal solution to form a metal coating layer.

13. The method of claim 12, further comprising heat treating the carbon nanofiber including the metal coating layer.

14. The method of claim 13, comprising heat treating at a temperature of about 390 to about 450° C.

15. The method of claim 12, wherein the carbon nanofiber on which the catalyst is distributed comprises about 5 to about 50 catalyst particles per about 100 nm² of the surface area of the carbon nanofiber.

16. The method of claim 12, wherein the catalyst comprises Pd, Pd—Sn alloy, or a combination thereof.

17. The method of claim 12, wherein the carbon nanofiber further comprises the metal catalyst on a region connecting truncated, conic graphene layers on both sides of the carbon nanofiber wall.
